(19) United States
(12) Patent Application Publication
(10) Pub. No.: US 2018/0236364 A1
(43) Pub. Date: Aug. 23, 2018

(54) INTERACTIVE DOLL STRUCTURE

(71) Applicants: MENG-YING CHAN, New Taipei City (TW); YIHSUAN LIN, Taipei City (TW); KO-YU CHANG, Taipei City (TW); LONG-FEI LIN, Fujian Province (CN)

(72) Inventors: Meng-Ying Chan, New Taipei City (TW); YIHSUAN LIN, Taipei City (TW); KO-YU CHANG, Taipei City (TW); LONG-FEI LIN, Fujian Province (CN); TING-WEI LIN, Taichung City (TW); CHIA-YU CHANG, Taichung City (TW); MIN-HUA LIN, Taipei City (TW); WEI-CHE HSU, New Taipei City (TW); RUI LIU, Guangdong Province (CN)

(21) Appl. No.: 15/890,515

(22) Filed: Feb. 7, 2018

(30) Foreign Application Priority Data
Feb. 21, 2017 (TW) 106105805

(51) Int. Cl. A63H 3/36; G06N 3/00; A63H 3/28

(52) U.S. Cl. CPC A63H 3/365; G06N 3/008; H04B 1/03; A63H 2200/00; A63H 3/28

(57) ABSTRACT

Disclosed is an interactive doll structure including a head portion, a body portion and a host. The head portion has at least a moving mechanism and at least a reader. The body portion is connected to the head portion and has at least another moving mechanism and at least another reader. The host is electrically connected to the moving mechanisms of the head portion and the body portion for controlling the movement of the moving mechanisms, and also electrically connected to the readers of the head portion and the body portion for controlling the head portion and/or the body portion to generate a corresponding operating mode when at least one of the readers reads an identifying tag from the outside.

### BACKGROUND OF INVENTION

### 1. Field of the Invention

The present invention relates to a doll structure, in particular to an interactive doll structure.

### 2. Description of the Related Art

In general, a common doll structure comes with various forms such as the forms of animals or human being. Further, some dolls have a movable doll structure. For example, the limbs of a doll can be operated manually by users (or children) to change the movement or appearance of the doll, so that the doll may be used as a recreational toy. To provide more operating functions such as a learning function, some doll structures has a voice playing function, wherein the users may press the doll structure to play the voice of a common word or phrase used in daily life for the learning of the users. However, the using effect and the operating mode of the aforementioned doll structure are limited.

### SUMMARY OF THE INVENTION

In view of the drawbacks of the prior art, the inventor of the present invention based on years of experience in the related industry to conduct extensive research and experiment, and finally designed and developed an interactive doll structure to overcome the drawbacks of the prior art.

Therefore, it is a primary objective of the present invention to overcome the aforementioned drawbacks of the prior art by providing a doll structure with interactive functions, particularly to the doll structure capable of producing corresponding actions or voice responses to promote children's cognitive learning.

To achieve the aforementioned and other objectives, the present invention provides an interactive doll structure comprising a head portion, a body portion and a host. The head portion has at least a moving mechanism and at least a reader. The body portion is connected to the head portion and has at least another moving mechanism and at least another reader. The host is electrically coupled to the moving mechanisms of the head portion and the body portion for controlling the movement of the moving mechanisms. The host is also electrically coupled to the readers of the head portion and the body portion for controlling the head portion and/or the body portion to generate a corresponding operating mode when at least one of the readers reads an external identifying tag.

In an embodiment of the present invention, the identifying tag is a radio frequency identification (RFID) tag, and the reader is a radio frequency identification (RFID) reader.

In an embodiment of the present invention, the host includes a sensor for sensing an external environment, so that the host can control the head portion and/or the body portion to generate the corresponding operating mode according to the sensed result of the sensor.

In an embodiment of the present invention, the host includes a wireless transmission module for connecting an external electronic device via a signal, so that the electronic device can operate the host.

In an embodiment of the present invention, the host includes a wireless network for connecting an external server, so that the server can record or update the data read by the reader.

In an embodiment of the present invention, the head portion has at least an input module for capturing external information, so that the host can control the head portion and/or the body portion to generate the corresponding operating mode according to the external information.

In an embodiment of the present invention, the head portion further has a movable face portion. The movable face portion is connected to the host via a signal and controlled by the host.

In an embodiment of the present invention, the host includes a voice recognition system for receiving and/or determining a voice input signal and/or a voice setting signal, and selectively generating the corresponding operating mode.

In an embodiment of the present invention, each of the readers is applicable for reading various types of identifying tags with different settings, so that the host can control the head portion and/or the body portion to generate the corresponding operating mode according to the setting of the identifying tag read by the reader.

From the description above, the interactive doll structure of the present invention comprises a head portion and a body portion, having a moving mechanism and a reader, and the host controls the moving mechanism and reader, so that when at least one of the readers reads an external identifying tag, the host controls the head portion and/or the body portion to generate the corresponding operating mode according to the read result of the reader, wherein the identifying tag is installed near the head portion and/or the reader is installed at the moving mechanisms of the head portion or the body portion, so that the head portion and/or the body portion can produce a swing movement, and the interactive doll structure of the present invention can provides users an interactive operating function.

### BRIEF DESCRIPTION OF THE DRAWINGS

FIG. 1 is a schematic block diagram of an interactive doll structure in accordance with an embodiment of the present invention; and

FIGS. 2 and 3 are schematic block diagrams showing a part of the operations of the interactive doll of FIG. 1.

### DESCRIPTION OF THE INVENTION

The above and other objects, features and advantages of this invention will become apparent from the following detailed description accompanied by the drawings.

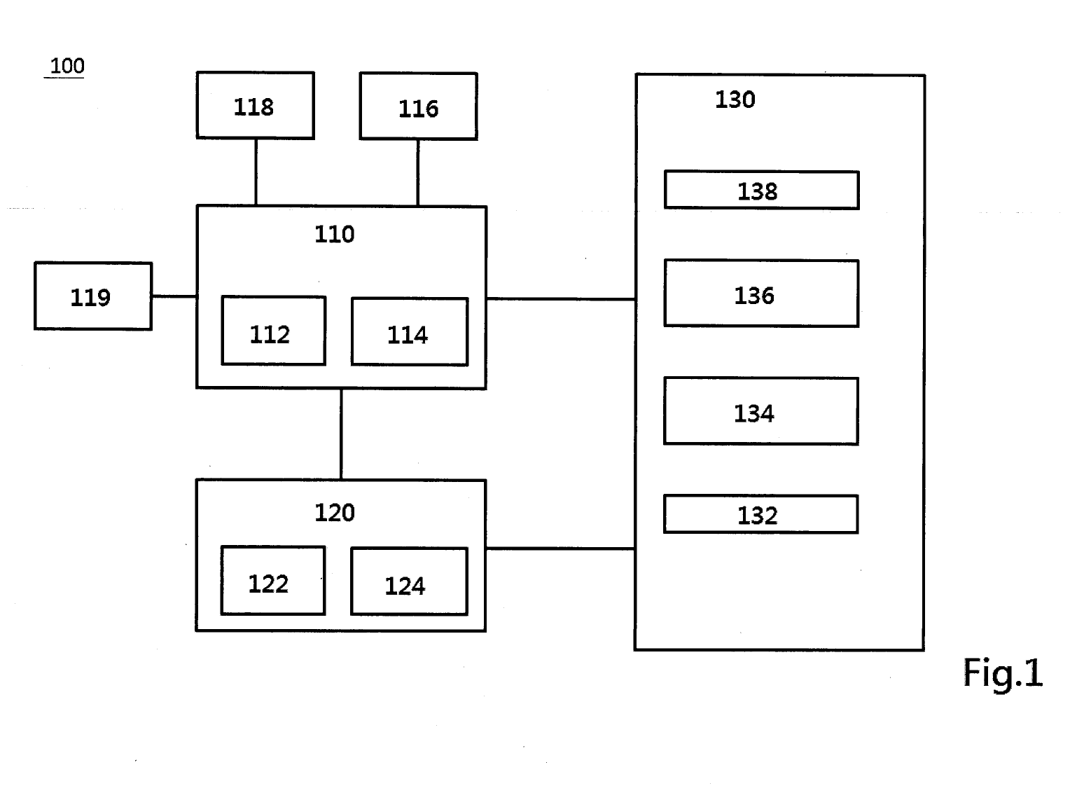

With reference to FIG. 1 for a schematic view of an interactive doll structure in accordance with an embodiment of the present invention, the interactive doll structure 100 comprises a head portion 110, a body portion 120 and a host 130. The body portion 120 is coupled to the head portion 110. For example, the interactive doll structure 100 is manufactured in the shape of an animal or a human being, and the interactive doll structure 100 has the head portion 110 and the body portion 120 coupled to each other. The body portion 120 of the interactive doll structure 100 may further have a hand portion and/or a leg portion (not shown in the figure) according to actual requirements, so that the interactive doll structure 100 may have various different kinds of movements. However, the shape of the interactive doll structure 100 of the present invention is not limited and may be adjusted according to actual requirements.

In the interactive doll structure 100, the head portion 110 has at least a moving mechanism 112 and at least a reader 114. Similarly, the body portion 120 has at least another moving mechanism 122 and at least another reader 124. Although each of the head portion 110 and the body portion 120 of this embodiment has a moving mechanism 112, 122 and a reader 114, 124, yet the interactive doll structure 100 of other embodiments may have a plurality of moving mechanisms and/or a plurality of readers, and the quantity of moving mechanisms and readers may be adjusted according to actual requirements.

In this embodiment, the moving mechanisms 112, 122 are provided for producing movements of the head portion 110 and/or the body portion 120. The movements may include a swing movement of the head portion 110 and/or the body portion 120 produced by the corresponding moving mechanisms 112, 122. In the embodiment of the body portion 120 having a hand portion and/or a leg portion, the hand portion and/or leg portion the corresponding moving mechanism 122 or other moving mechanism produce a swing movement. The quantity, position and use of the moving mechanisms 112, 122 of the present invention are not limited but they can be adjusted according to actual requirements. The movement of the moving mechanisms 112, 122 is controlled by the host 130, and the readers 114, 124 are provided for the host 130 to control the movement of the moving mechanisms 112, 122.

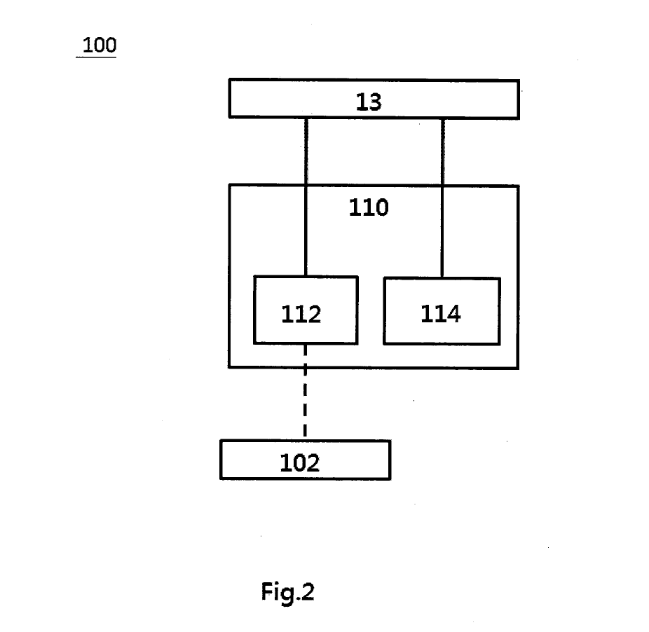

Specifically, the host 130 of this embodiment is electrically coupled to the moving mechanisms 112, 122 of the head portion 110 and the body portion 120 for controlling the movement of the moving mechanisms 112, 122 and electrically coupled to the readers 114, 124 of the head portion 110 and the body portion 120 for controlling the head portion 110 and/or the body portion 120 to generate a corresponding operating mode when the reader 114, 124 reads at least an external identifying tag 102 (as shown in FIG. 2). For example, the operating mode includes the swing movement produced by the head portion 110 and/or the body portion 120, or any operating mode other than those of the movements, and the details will be described below.

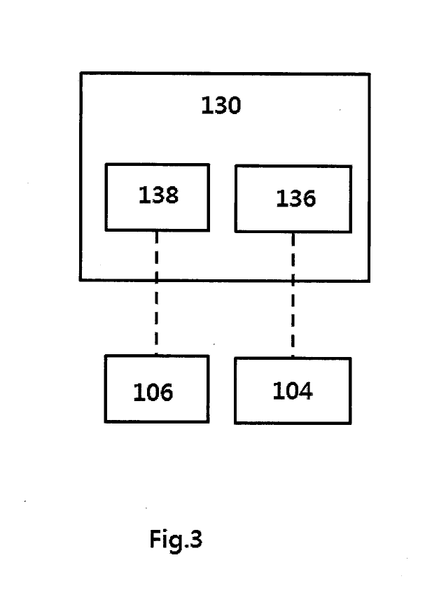

With reference to FIGS. 2 and 3 for the schematic views showing some operations of the interactive doll structure of FIG. 1, the identifying tag 102 (as shown in FIG. 2) of this embodiment is a radio frequency identification (RFID) tag, and the reader 114, 124 is a radio frequency identification (RFID) reader. The present invention is not limited to such arrangement only, but can be adjusted according to actual requirements. The identifying tag 102 may be manufactured to any external items of the interactive doll structure 100, such as being attached or built into daily necessities or a standalone object. For example, the reader 114 is installed at the head portion 110, so that when a user (such as a child) carrying a standalone identifying tag 102 or an object with an identifying tag 102 approaches the reader 114, the reader 114 can identify the related settings of the identifying tag 102, and the host 130 electrically coupled to the reader 114 controls the head portion 110 according to a read result, and the moving mechanism 112 produces a movement (such as a swing movement), [symbol] so as to achieve the interactive effect.

Similarly, the head portion 110 of this embodiment may have an output module 116 (as shown in FIG. 1) such as a speaker or a screen (whose type and quantity are not limited in the present invention). According to the aforementioned operation, when the user with the standalone identifying tag 102 or carrying an object with the identifying tag 102 approaches the reader 114, the reader 114 can identify the related settings of the identifying tag 102, and the host 130 electrically coupled to the reader 114 can drive the output module 116 of the head portion 110 to output a related result (such as playing the sound of a word or outputting a corresponding image) according to the read result. Therefore, the identifying tag 102 may be manufactured onto an object, so that when the identifying tag 102 is approaching the reader 114, the output module 116 may play the sound of the word corresponding to the object, or the identifying tag 102 may be manufactured to be a word card, so that when the identifying tag 102 is approaching the reader 114, the output module 116 may output the image corresponding to the word, so as to achieve the learning effect.

In the aforementioned technical solution, the reader 114 of the head portion 110 reads the identifying tag 102 to generate a corresponding operating mode, or the reader 113 of the body portion 120 may be implemented (such that the body portion 120 is electrically coupled to the output module 116 or another output module is installed), so that even when the reader 124 of the body portion 120 reads the identifying tag 102 or the other identifying tag, and the corresponding operating mode (such as producing a movement or outputting corresponding information) is generated, the operating modes produced in the aforementioned two cases may be the same or different. The present invention is not limited to such arrangement, but can be adjusted according to actual requirements.

In this embodiment, each reader 114, 124 is applicable for reading various types of identifying tags with different settings, so that the host 130 can control the head portion 110 and/or the body portion 120 to generate a corresponding operating mode according to the setting of different identifying tags read by the reader 114, 124, or a single identifying tag 102 may be used, and the setting of the identifying tag 102 may be changed according to actual requirements (and the way of changing will be described below). Therefore, the user can set an identifying tag with a different setting (such as the one with a corresponding word or phrase) near one of the readers 114, 124, and thus the host 130 can control the head portion 110 and/or the body portion 120 to produce a movement (such as the movement corresponding to the word or phrase) according to the settings read by the reader 114, 124 (such as the corresponding word or phrase of the identifying tag, or the related result (such as playing the corresponding sound set by a word or a phrase) is outputted by the output module 116. The operating modes are the same as those described above, and thus will not be repeated.

In the embodiment as shown in FIG. 1, the related operating mode is generated after the reader 114, 124 reads the identifying tag 102, but the interactive doll structure 100 of this embodiment may interact with users through other methods.

In a specific embodiment, the host 130 includes a sensor 132 for sensing external environment, so that the host 130 can control the head portion 110 and/or the body portion 120 to generate a corresponding operating mode according to a result sensed by the sensor 132. For example, when the sensor 132 senses an external environment changing from nighttime to daytime (or changing from dark light to bright light), the host 130 can control the output module 116 to output a voice to notify the user according to the result sensed by the sensor 132. Therefore, the output module 116 may be used as an alarm or a reminder (such as reminding the user to brush her/his teeth), or when the sensor 132 senses a too-bright or too-dark light in the environment, the host 130 can control the output module 116 to output a voice to remind the user to turn on/off the lamp according to the result sensed by the sensor 132, or the head portion 110 or the body portion 120 may be swung to further improve the interaction. The present invention is not limited to a specific implementation of the sensor 132 or its installation, and it can be adjusted according to actual requirements.

In this embodiment, the head portion 110 further has at least an input module 118 for capturing external information, so that the host 130 can control the head portion 110 and/or the body portion 120 to generate a corresponding operating mode according to the external information. For example, the input module 118 may be a camera or a microphone for capturing the external information such as the user's image or voice conversation. After the host 130 determines the content of the external information (such as the user's image or voice conversation), the movement (such as a swing movement) produced by the head portion 110 and/or the body portion 120 or the corresponding result (such as outputting a voice) outputted by the output module 116 can be controlled for the interaction.

In this embodiment, the head portion 110 further has a movable face portion 119. The movable face portion 119 is coupled to the host 130 via a signal and controlled by the host 130. For example, after the input module 118 captures the external information such as the user's image or voice conversation, the host 130 controls the movable face portion 119 to produce a facial expression according to the external information to improve the interaction. Similarly, the host 130 using the reader 114, 124 to read the identifying tag 102 or the sensor 132 to sense the external environment to control the head portion 110 and/or the body portion 120 to generate the operating mode may also control the movable face portion 119 to produce a movement such as controlling the eyebrows, eyes, ears, or lips, etc. The present invention is not limited to such implementation methods only, but it can be adjusted according to actual requirements.

In this embodiment, the interactive doll structure 100 inputs voice information through the input module 118, so that the host 130 of this embodiment further includes a voice recognition system 134. The voice recognition system 134 is provided for receiving and/or determining a voice input signal and/or a voice setting signal, and selectively generating a corresponding operating mode. For example, after the input module 118 captures a user's voice conversation, the voice recognition system 134 can receive the voice input signal and determines the content of the voice input signal. If the voice input signal is determined to be a signal of bad sentence, then the host 130 will control the output module 116 not to output the corresponding voice result or just output the corrected information, so as to correct the bad sentence issued by the user. In addition, the voice recognition system 134 may receive a voice setting signal, so that the host 130 can read the identifying tag 102 by the reader 114, 124 or can sense the external environment by the sensor 132, and can control the output module 116 to output the related voice after the voice is recognized by the voice recognition system 134. The present invention is not limited to such implementation method only, but it can be adjusted according to actual requirements.

With reference to FIGS. 1 and 3 for this embodiment, the host 130 includes a wireless transmission module 136, for connecting the external electronic device 104 via a signal, and the electronic device 104 is provided for operating the host 130. Specifically, the wireless transmission module 136 is a Bluetooth transmission module or any other wireless transmission module. The type of the wireless transmission module 136 of the present invention is not limited. Through the wireless transmission module 136, the user may use an external electronic device 104 such as a mobile phone to connect to the reader 114, 124 set in the host 130 in advance to read the type of the identifying tag 102 or set the reader 114, 124 to read the type of the operating mode generated after reading the same identifying tag 102, and the identifying tag 102 can be used in a diversified manner (without the need of using a plurality of identifying tags, but simply changing the setting of the corresponding identifying tag to adjust the type of the operating mode), so as to improve the diversification of the interaction.

In this embodiment, the input module 118 and the output module 119 are installed, so that a user (such as a child) may use the information (such as an image or a voice) captured by the input module 118 or use the wireless transmission module 136 to send the information to another user (such as the child's parent) carrying the electronic device 104, and another user may use the wireless transmission module 136 to send the image data or voice conversation and output the image data or voice conversation through the output module 119 to a user using the interactive doll structure 100. The present invention is not limited to the aforementioned implementation method only, but may be adjusted according to actual requirements.

In this embodiment as shown in FIGS. 1 and 3, the head portion 110 of the interactive doll structure 100 has the input module 118 capable of capturing the external information and the host 130 has a sensor 132 and a voice recognition system 134 capable of sensing the external information and receiving and/or determining a voice input signal or a voice setting signal, so that the host 130 may further include a wireless network 138 for connecting an external server 106, and the server 106 records or updates the data read by the reader 114, 124, the external information captured by the input module 118, the result sensed by the sensor 132, and/or the voice input signal and/or the voice setting signal received by the voice recognition system 134. Therefore, the user can record the using result of the interactive doll structure 100 periodically in order to know a child's daily usage of the interactive doll structure 100, or adjust the related setting by the wireless transmission module 136 and the external electronic device 104. The present invention is not limited to the aforementioned implementation method only, but it can be adjusted according to actual requirements.

In summation of the description above, the interactive doll structure 100 of the present invention has the moving mechanisms 112, 122 and the readers 114, 124 installed at the head portion 110 and the body portion 120, and the host 130 is provided for controlling the moving mechanisms 112, 122 and readers 114, 124. In addition, the head portion 110 may have the output module 116 and the input module 118, and the host 130 may have the modules including the sensor 132, the wireless transmission module 136, the wireless network 138, etc. When at least one external identifying tag 102 of the readers 114, 124 (such as the user's identifying tag 102) is approaching the readers 114, 124 of the head portion 110 or the body portion 120, the input module 118 captures external information, or the sensor 132 senses an external environment, the host 130 controls the head portion 110 and/or the body portion 120 to generate a corresponding operating mode according to the read result of the readers 114, 124, the captured result of the input module 118, or the sensed result of the sensor 132. For example, the moving mechanisms 112, 122 installed at the head portion 110 or the body portion 120 are controlled, so that the head portion 110 and/or the body portion 120 produce a movement, or the output module 116 is controlled to produce the corresponding voice information, so as to achieve the interactive operating function. Therefore, a user (such as a child) can use the aforementioned operating mode of the interactive doll structure 100 for learning, and another user (such as the child's parent) may use the wireless transmission module 136 and the wireless network 138 to interact or observe the user's learning condition, so as to improve the practicability of the interactive doll structure 100.

While the invention has been described by means of specific embodiments, numerous modifications and variations could be made thereto by those skilled in the art without departing from the scope and spirit of the invention set forth in the claims.

What is claimed is:

1. An interactive doll structure, comprising:
a head portion, having at least a moving mechanism;
a body portion, coupled to the head portion, and having at least another moving mechanism;
a reader, installed at the head portion or the body portion; and
a host, electrically coupled to the moving mechanisms of the head portion and the body portion for controlling the movement of the moving mechanisms, and electrically coupled to the readers of the head portion and the body portion for controlling the head portion and/or the body portion to generate a corresponding operating mode when at least one of the readers reads an external identifying tag.

2. The interactive doll structure of claim 1, wherein the identifying tag is a radio frequency identification (RFID) tag, and the readers is a radio frequency identification (RFID) reader.

3. The interactive doll structure of claim 1, wherein the host includes a sensor for sensing an external environment, such that the host can control the head portion and/or the body portion to generate the corresponding operating mode according to a sensed result of the sensor.

4. The interactive doll structure of claim 1, wherein the host includes a wireless transmission module for connecting an external electronic device via a signal, so as to operate the host by the electronic device.

5. The interactive doll structure of claim 1, wherein the host includes a wireless network for connecting an external server, and the server is provided for recording or updating the data read by the readers.

6. The interactive doll structure of claim 1, wherein the head portion has at least an input module for capturing external information, so that the host can control the head portion and/or the body portion to generate the corresponding operating mode according to the external information.

7. The interactive doll structure of claim 1, wherein the head portion further has a movable face portion coupled to the host via a signal and controlled by the host.

8. The interactive doll structure of claim 1, wherein the host includes a voice recognition system for receiving and/or determining a voice input signal and/or a voice setting signal, and selectively generating the corresponding operating mode.

9. The interactive doll structure of claim 1, wherein each of the readers is applicable for reading various types of identifying tags of different settings, so that the host can control the head portion and/or the body portion to generate the corresponding the operating mode according to the setting of the identifying tag read by the reader.
